(19) United States
(12) Patent Application Publication
(10) Pub. No.: US 2014/0345061 A1
(43) Pub. Date: Nov. 27, 2014

(54) High voltage cable preparation tool

(71) Applicant: Terry Lingmann, Oregon City, OR (US)

(72) Inventor: Terry Lingmann, Oregon City, OR (US)

(21) Appl. No.: 14/284,230

(22) Filed: May 21, 2014

Related U.S. Application Data
(60) Provisional application No. 61/826,478, filed on May 22, 2013.

(51) Int. Cl. H02G 1/12; B25B 7/22

(52) U.S. Cl. CPC H02G 1/1224; B25B 7/22
USPC 7/107

(57) ABSTRACT

An improved lineman plier for prepping high voltage power cable cut ends, comprising a first body pivotally connected to a second body, the first body having a handle on one end, an upper jaw on the other having at least one upper transverse gripping edge and an upper jaw tip having at least one tooth, the second body having a handle on one end, a lower jaw on the other having at least one lower transverse gripping edge, a lower jaw tip, and protrusion projecting from the lower jaw, the lower jaw tip having at least one cutter and blade protruding into a void defined between the upper and lower jaw, such that when a high voltage cable is secured within the void and squeezed between the upper lower jaw, the outer insulation jacket is cut by the blade when the handles are rotated about the cable axis.

### CROSS-REFERENCE TO RELATED APPLICATION

This application claims priority under 35 U.S.C. §119(e)(1) to U.S. Ser. No. 61/826,478, filed May 22, 2013, which is hereby incorporated by reference in its entirety.

### TECHNICAL FIELD

The invention generally pertains to special purpose linesman pliers and more specifically to the type that have provisions to prepare a high voltage power transfer cable for electrical connection.

### BACKGROUND OF INVENTION

High voltage power transfer cables such as used to transfer over a million volts of electrical power, are generally configured with the high power conductor wires for carrying the electrical power located at the center of the cable, molded within a first layer of insulation. Immediately around the circumference of the exterior of the first layer of insulation, a plurality of neutral conductor wires radially propagating parallel along the length of the cable, the neutral conductor wires being embedded within an outer insulating jacket.

A linesman who is specialized in the trade of prepping, repairing, and connecting high voltage power cables is repetitively required to prepare a cut cable for conductor connection in compromised locations, such as in a trench or vault. High voltage power cables are stiff, large in circumference, and difficult to bend. The conventional tool for this procedure is a so called “linesman pliers”, which incorporate a solid joint with diagonal cutting blades and crimping surfaces, as well as jaws that are used to grip and hold the stripped wires.

The standard high voltage cable prepping process involves a knife, lineman plier, and a linesman performing the following steps using a knife, a snip, and a plier :
1. Making a circumferential cut around the outer insulating jacket with a knife;
2. Clipping or scoring with a snip the outer insulating jacket at the cut end adjacent to one neutral wire, until the neutral wire is exposed;
3. Longitudinally scoring or cutting the outer insulating jacket with a knife or snip to define a path to tear the neutral wire through the insulating jacket;
4. Grabbing one of the neutral conductor wires with a plier, and pulling one neutral wire ¼″ to ½″ out of the insulation;
5. Re-grabbing the neutral wire with a plier and then squeezing the handles hard enough to hold secures the neutral wire;
6. While squeezing with significant force the plier handles, pulling the neutral conductor wire approximately 180 degrees to the cut cable end with substantial ripping force, thereby pulling the neutral wire through the insulating jacket along the longitudinal cut until reaching the circumferential cut;
7. With a snip, gripping and cutting the insulating jacket down to the circumferential cut; and
8. Clearing the neutral wires by pulling the insulating jacket off with the plier.

The physical force required to rip the neutral wire through the outer insulating jacket is substantial, and often requires a hard yank followed by a braced body pull even if the tear line is pre-scored. Lineman performing this cable prepping task have a history of suffering strain injuries, recurring motion disorders, repetitive stress injuries, and if the grip on the wire is lost suddenly, trauma injuries.

### BACKGROUND OF THE RELATED ART

Pliers for cutting insulation jackets, stripping wires, or gripping wires are well known in the art and date back to the 1900's with Inventor J. Irwin's U.S. Pat. No. 924,357 dated June 1909. The opposing pivoting jaws common for most all plier tools were improved for lineman type work. The Irwin improvement included specialized beveled blade element attached to the upper jaw between the pivot axis and the jaw tips. The beveled blade (shown as 15 in patent 924,357) was settable for a cutting depth matching the particular insulation thickness. When used, the insulated wire was captured between the upper and lower jaw, such that when the pliers are rotated circumferentially, the wire is held by the groove (22) in the opposing lower jaw, and the beveled blade (15) circumferentially cuts the insulation. As shown in FIG. 1, Irwin further teaches a ridge (19) on the tip of the upper jaw that presents functionally as a tooth that bites into the insulation to permit the removal, thereby stripping the wire in preparation for electrical connection. The Irwin improvement was aimed to solve the problem of stripping a single core conductor wire covered in one insulation sheath, and would not be workable as used to prepare high voltage cable that has multiple layers of insulation with neutral conductor wires embedded radially around the central main conductor wire.

U.S. Pat. No. 969,339, issued to Chytraus on Sep. 6, 1910, teaches a device for cutting insulation from conductors manually using a pair of knife blades positioned parallel and perpendicularly to the conductor wires, respectively, to perform the cutting. As shown by reference numbers 16 and 21 of FIG. 1 of the patent. U.S. Pat. No. 3,614,905, issued to Bieganski on Oct. 26, 1971, a cable stripping apparatus using a pair of cutters used to apply an annular incision to the outer insulation jacket that is then removed axially away from the remainder of the conductors to expose the underlying conductors. Nothing in the Chytraus patent disclosure or the Bieganski patent suggested a feature of the tool for gripping and ripping the wire through the outer insulating jacket in one motion after performing the annular cutting circumferentially around the high voltage cable. All cutting was performed by blades rather than using the conductor wire itself to rippingly tear through the insulation.

Other prior art attempts to solve the problem of clearing and stripping high voltage cables for electrical connection involve automated machines or power tools to apply the necessary forces to avoid injuring workers, and to speed up production. The ‘Automatic Field Cable Stripper’ having U.S. Pat. No. 6,668,458 by Schoenleber uses a cordless drill to remove the outer insulation jacket to expose the neutral wires. Schoenleber's device solves the problem of prepping a high voltage cable, but requires a power drill to operate.

Looking to more recent prior art examples involving simple hand tools that do not require power assist, an improved Wire-Stripping Pliers by Te-Huang Chiu having patent no. U.S. Pat. No. 7,958,803 teaches a longitudinal stripping of the outer insulation jacket to strip and clear the conductor wires using a jaw fixed blade that is pulled down the cable to cut off the insulation. The Chiu plier as depicted in FIGS. 2 and 3 does not utilize the wire within the insulation to assist in cutting through the insulation, and requires the user to exert the full force without lever advantage when cutting away the insulation.

There is an unfulfilled need for a hand tool that can prep a high voltage cable end for connection. There are tools that can spool up the neutral wire in preparation for connection after the initial stripping or clearing of the outer insulation jacket. To example such a tool, the Cable-Ripping Tool by Jones et. al having Pub. No.: U.S. Pat. No. 2012/0311866 A1 described a tool that spooled the neutral wire after the initial preparations were complete:
1. A tool comprising:
a spool;
a clamping assembly connected to the spool, the clamping assembly comprising at least two clamping members moveable relative to each other to clamp onto a cable within a clamped region between the two clamping members;
one or more gripping members attached to the spool and configured to hold a wire that is being wound from the cable onto the spool; and
a driving mechanism attached to the spool, the driving mechanism being configured to rotate the spool and wind the wire onto the spool.

Jones et. al. teaches that the winding of the wire on the spool as being performed contemporaneous with the ripping of the neutral wire through the outer insulation jacket, however for the Jones tool to operate, the neutral wire needed to be initially pulled out and cleared 1-¼″ to 2″of the cable's outer insulation jacket as explained in the Jones' specification (starting on page 3, paragraph 0040):
VI. Use of the Cable-Ripping Tool
Use of the cable-ripping tool (100) will now be described. A cable (130) can be prepared for use with the tool (100) by gripping one of the neutral wires (132) on an end of the cable (130) with pliers and pulling the neutral wire (132) through the jacket (134), so that a portion of the neutral wire (132) is extending roughly perpendicular to the cable (130). For example, about 1 ¼ inch to about 2 inches of the neutral wire (132) may extend away from the cable (130) in this manner.

The Jones tool filed in June 2011 identified that pliers were the appropriate tool to pull the neutral wire through the jacket in order to expose the wire adequately for the Jones tool to grip and then spool the neutral wire. However, as discussed above, the standard plier, or even the commonly used lineman type plier requires substantial force to be exerted by the user in order to rip the wire through the outer insulation jacket.

Thus an improved plier, specifically an improved lineman type plier for initially prepping high voltage power transfer cables that removes the outer insulation jacket and clears the neutral wires thereby solving the aforementioned problems is greatly desired.

### SUMMARY OF THE INVENTION

In the preferred embodiment, an object of the invention is to overcome the shortcomings of the conventional linesman pliers by decreasing the manual forces required to operate when prepping the end of a high voltage power transfer cable, thereby increasing safety, decreasing injury, while improving production.

One advantage of the described invention involves the reduced manual forces that are required to pull the neutral wire through the insulation jacket.

One object of the invention is to incorporate a lever advantage, specifically a protrusion from the lower jaw that is substantially aligned with a cutter that work cooperatively to reduce the required force exerted by the linesman when ripping a neutral wire through an insulating jacket.

Another important object of the preferred embodiment is that it easily and cleanly captures the neutral wire with specialized jaw tips that may be integrally formed within the upper jaw, wherein the upper jaw tip has at least one predator like tooth for biting into or deforming the end of the cable's insulation, to capture a neutral wire, all with minimal manual force applied to the handles, with one hand in one motion.

Another object of the preferred embodiment involves positive securement of the neutral wire with opposing transverse gripping edges located in the upper and lower jaws that receive the captured wire conductor, and positively secures the same with minimal force at the handle by cooperatively deforming the wire with a sharp bend between the transverse gripping edges that compress the sharp bend such that the hold on the conductor wire is maintained with minimal opposing force at the handles as applied by the user.

Yet another object of the preferred embodiment is the circumferential cutting feature that is performed by a robust open jaw design which includes a replaceable scoring blade and guard in the lower jaw to facilitate circumferential scoring or cutting of the insulation jacket without the need of a knife.

Another advantage of the preferred embodiment involves retention of full function as the traditional tool used by linesmen. The traditional functionality of the plier include the wire cutter and wire crimper, which remain in traditional function and location. The improved lineman plier's features and elements do not conflict with either the wire cutter's use or the crimper's functionality as located immediately fore and aft of the pivot point,

Yet another object of the preferred embodiment is that the functionality and performance of the plier is greatly increased at little expense to the manufacturing costs.

These and other objects and advantages of the present invention will become apparent from the subsequent detailed description of the preferred embodiment and the appended claims taken in conjunction with the accompanying drawings.

### BRIEF DESCRIPTION OF THE DRAWING

An embodiment of the invention will now be described by way of illustrative drawings from different perspectives as depicted in the accompanying figures, in which;

FIG. 1 is a left side perspective view of the high voltage cable preparation tool.

FIG. 2 is a right side view of FIG. 1.

FIG. 3 is a left side view of FIG. 1.

FIG. 4 is a close up perspective bottom right view of the improved plier's jaws of FIG. 1 in the open position.

FIG. 5 is a close up perspective upper left view of the improved plier's jaws of FIG. 1 in the open position.

### DETAILED DESCRIPTION OF THE DRAWINGS

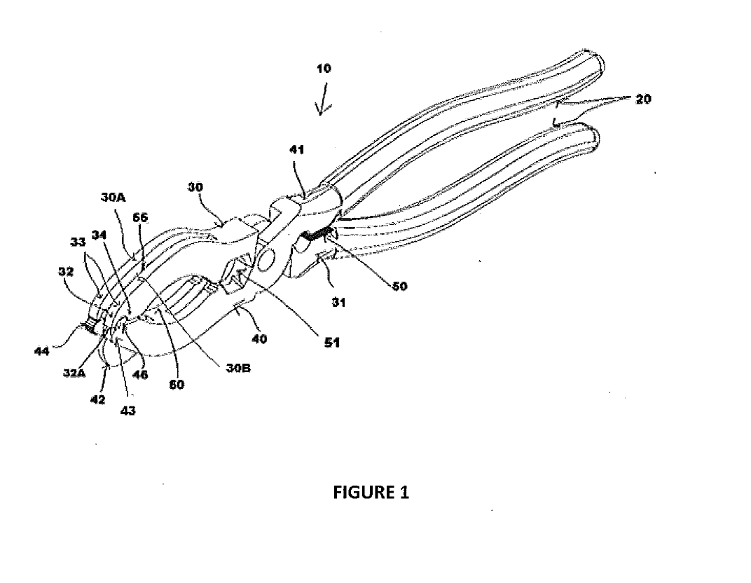

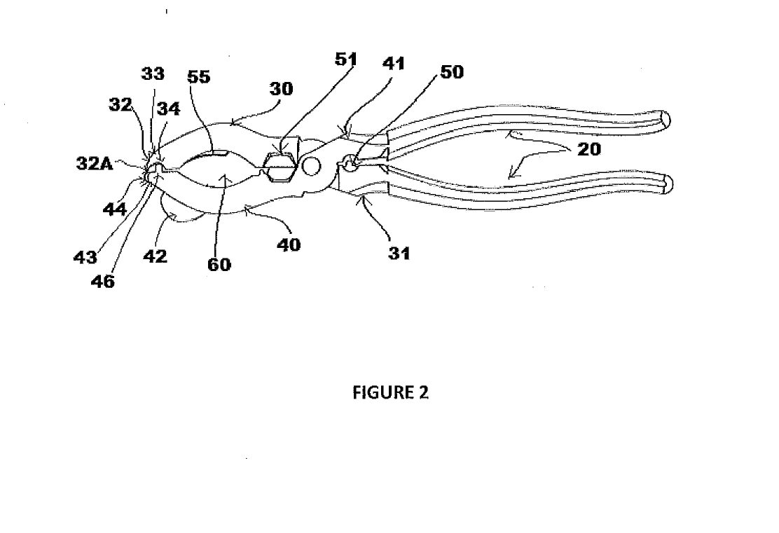

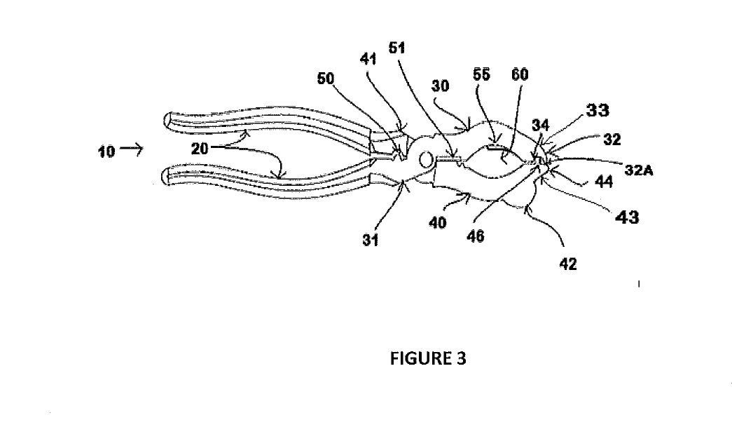

The best mode for carrying out the cable preparation tool is disclosed in terms of a preferred embodiment for an improved plier 10 as depicted in FIGS. 1-5. The improved plier 10 having a first body 31 pivotally connected to a second body 41, similar to traditional linesmen pliers that includes a wire cutter 51 and wire crimper 50.

### First Body and Upper Jaw

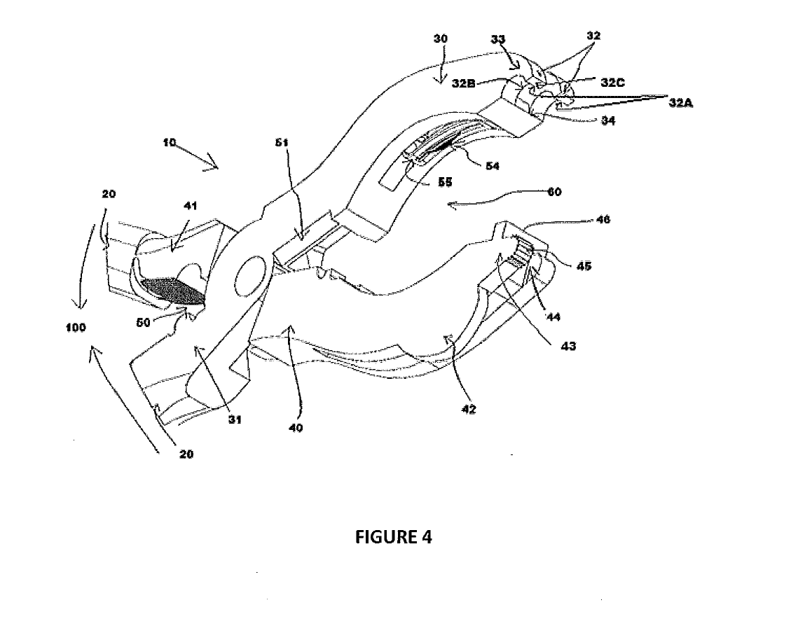

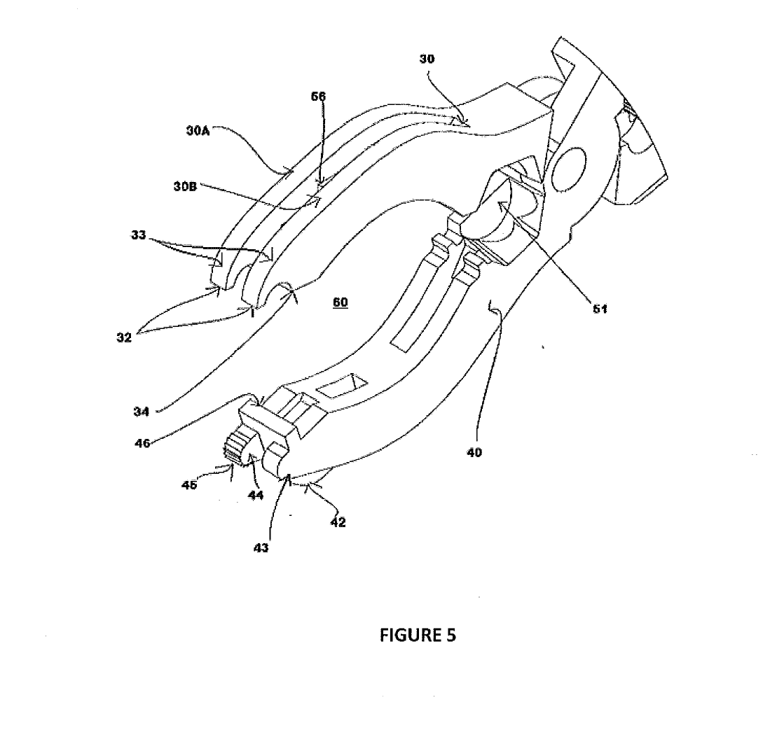

The first body 31 having a handle 20 on one end, with an upper jaw 30 on the other, the upper jaw 30 having at least one upper transverse gripping edge 34 and at least one upper jaw tip 33, the upper jaw tip 33 having at least one tooth 32 integrally formed therefrom. In other embodiments the tooth 32 is a discrete component that removably engages the upper jaw tip 33 and is a replaceable component of the improved plies 10. The upper jaw 30 further includes an oblong void 60 in which a blade 54 (shown in FIGS. 4 and 5) and guard 55 fixates therein to enable circumferential cutting or scoring of the insulation jacket. In other embodiments the blade 54 is changeable and replaceable both with and without the guard 55. The upper jaw 30 as shown in FIGS. 1 and 5 being constructed from two side by side elements 30A and 30B, which allows for a replaceable blade 54 and guard 55 there between. In other embodiments the upper jaw 30 and lower jaw 40 are constructed from continuous solid metal, rather than dual side elements 30A and 30B.

### Upper Jaw Tooth

As depicted illustratively in FIG. 1-3 the preferred embodiment of the tooth 32 is constructed and arranged to deform or penetrate through the insulation at the cut end of a cable to grab a neutral wire there within, the tooth 32 terminating in at least one sharp edge 32A which assists in separating the neutral wire from the insulation. As depicted in FIG. 4, the tooth 32 is shown with a flat tip 32C surface fashioned to deform or press down the insulation, to expose and initially grab the neutral wire from the cut end of the cable with the sharp edge 32A. In other embodiments the tooth 32 includes a sharpened or beveled blade edge along the interior radius 32B and the flat tip 32C is configured into a sharp point, thereby reducing the force needed to pierce, cut, and penetrate the cut end of the cable when capturing the neutral wire. As discussed above, the upper jaw tip 33 and tooth 32 are integrally formed for the preferred embodiment, but in other embodiments the tooth 32 is fixated to the upper jaw tip 33 rather than integrally formed, thereby allowing for easy replacement or changing of the tooth 32.

### Second Body and Lower Jaw

The second body 41 having a handle 20 on one end, a lower jaw 40 on the other, the lower jaw 40 having at least one lower transverse gripping edge 46, at least one lower jaw tip 43 and a cutter 44 integrally formed therefrom, and at least one protrusion 42 projecting externally from the lower jaw 40 and substantially aligned with the cutter 44.

### Cooperative Upper and Lower Jaws

As depicted in FIG. 5 as a close up illustrative perspective view of the improved plier 10, the upper jaw 30 works cooperatively with the lower jaw 40 such that the upper jaw tooth 32 deforms or penetrates the cable end capturing a conductor wire contemporaneous with the cutter 44 piercing or biting into the cable's outer insulation jacket proximal to the cut end thereby distressing the insulation while firmly aligning the tool with the cable. At least one upper jaw tooth 32 in the upper jaw 30 and the cutter 44 from the lower jaw 40, cooperatively compress, deform, and effectively bite into the end of the cut cable to capture a neutral wire such that when the handles 20 are brought together and pushed down, the neutral wire is deformed and positively secured between the lower transverse gripping edge 46 of the lower jaw 40, and the upper transverse gripping edge 34 of the upper jaw 30.

### Protrusion and Cutter

This improved plier 10 as depicted in its preferred right hand embodiment in FIGS. 1-5 is shown with only one cutter 44 and one protrusion 42, both shown on one side of the lower jaw 40. One skilled in the art will immediately realize the benefit of having the cutter 44 and protrusion 42 located on the right side for left handed lineman, or including more than one cutter 44 and protrusion 42 to provide ambidextrous usage. In other embodiments the protrusion 42 is integrally formed together with the cutter 44. Also, the protrusion 44 size may be increased or decreased in relative diameter or dimension proportionately to the length of neutral wire desired to be pulled from the cable end, or proportionately to the amount of preferred user leverage.

### Cutter

The preferred cutter 44 as shown in FIGS. 4 and 5 includes stepped edges 45 for aligning, gripping and biting into the insulation. These edges 45 that are disposed substantially parallel to the upper jaw teeth 32 cooperatively hold or jointly grip the cable's outer insulating jacket while the upper jaw teeth 32 shear the insulation against the cutter's 44 edges 45. The cutter 44 and upper jaw tooth 32 work together to accomplish the function of a snip. The cutter 44 could be of many suitable shapes, sizes, and blade edge types to accommodate insulation thickness, and insulation type. As discussed above, in the preferred embodiment the cutter 44 is integrally formed with the lower jaw tip 43, in other embodiments the cutter 44 is fixated to the lower jaw tip 43 rather than integrally formed, thereby allowing for easy replacement of the cutter 44 when it becomes worn or damaged.

### Protrusion

As shown in FIG. 1, 2, and depicted in use in FIG. 5, the protrusion 42 is constructed and arranged to contact the exterior insulation jacket of the cable when the handles 20 are pushed towards the cable, thereby providing a lever point whereby the forces exerted on the handles 20 are multiplied perpendicular in direction to the cable at the upper jaw tip 33, thereby reducing the manual forces necessary at the handles 20 to rip the conductor wire through the outer insulation jacket during cable preparations. The protrusion 42 shown in FIGS. 1, 2, and 5 benefits from a convex curved (e.g., semicircular) shape as integrally formed from the lower jaw 40 extending radially outward, providing a leverage contact surface between the pliers 10 and the cable. With the protrusion 42 in contact with the cable, the plier 10 acts as a mechanical lever with the force at the handles 20 being multiplied at the upper 33 and lower jaw tips 43. The mechanical advantage is calculated by dividing the length of the effort arm by the length of the load arm. In this—example the distance between the protrusion 42 cable contact point and the handle 20 is the effort arm and the distance between the jaw tips 33, 43 and the protrusion 42 contact point is the load arm, with the protrusion 42 being the fulcrum.

In the preferred embodiment, the force exerted on the handles 20 is multiplied several times by the mechanical advantage of the protrusion 42, thereby significantly reducing the physical forces required by the lineman when ripping out a stripped conductor wire. As mentioned above, the size of the protrusion 42 may be increased or decreased to adjust the desired length of conductor wire to be pulled and stripped from the cable. The larger the radius of the protrusion 42, the more of the neutral wire is ripped through the outer insulation jacket.

### Circumferential Cut and Score

As shown by illustrative close up view in FIG. 4 with the upper jaw 30 and lower jaw 40 open as if ready to receive a cut power cable end, the improved pliers 10 further include an oblong void 60 defined there between the upper jaw 30 and lower jaw 40. When the improved pliers 10 are used rather than a knife to perform the first step in stripping the insulation jacket from a high voltage power cable, the lineman locates the cable within the upper jaw 30 and lower jaw 40, such that when the handles 20 are squeezed together 100, the blade 54 is exposed from the guard 55 and penetrates the outer insulation jacket to a pre-set depth. The handles 20 are then rotated around the axis of the cable thereby cutting or scoring circumferentially the cable at the selected location at a predetermined depth. The upper jaw 30 as shown is constructed and arranged to removably receive the blade 54 and guard 55, making both easily replaced in the field. In other embodiments the blade 54 and guard 55 are located in the lower jaw 40 similar to the fixation in the upper jaw 30 depicted in FIG. 4. The blade 54 and guard 55 for the preferred embodiment assemble together before being received by the plier 10 similar to a razor cartridge. Other embodiments the blade 54 and guard 55 are separately installed. The inventive pliers 10 still maintain the standard features of the traditional linemen pliers, in that the wire cutter 51 and wire crimper 50 remain in traditional function and location.

While the preferred embodiment of the invention has been described in illustrative detail in the accompanying drawings, it is not to be limited to such details, since many changes and modifications may be made to the invention without departing from the spirit and scope thereof. Hence, it is described to cover any and all modifications and forms which may come within the language and scope of the appended claims.

What I claim is:

1. An improved lineman type plier having provisions for prepping a high voltage cable end, comprising:
a first body 31 pivotally connected to a second body 41;
the first body 31 having a handle 20 on one end, an upper jaw 30 on the other end, the upper jaw 30 having at least one upper transverse gripping edge 34 and an upper jaw tip 33, the upper jaw tip 33 having at least one tooth 32;
the second body 41 having a handle 20 on one end, a lower jaw 40 on the other end, the lower jaw 40 having at least one lower transverse gripping edge 46, a lower jaw tip 43, and a protrusion 42 projecting from the lower jaw 40, the lower jaw tip 43 having at least one cutter 44 substantially aligned with the protrusion 42.

2. An improved lineman type plier of claim 1, further comprising:
a first body 31 pivotally connected to a second body 41;
the first body 31 having a handle 20 on one end, an upper jaw 30 on the other end, the upper jaw 30 having at least one upper transverse gripping edge 34 and an upper jaw tip 33, the upper jaw tip 33 having at least one tooth 32;
the second body 41 having a handle 20 on one end, a lower jaw 40 on the other end, the lower jaw 40 having at least one lower transverse gripping edge 46, a lower jaw tip 43, and a protrusion 42 projecting from the lower jaw 40, the lower jaw tip 43 having at least one cutter 44; and
at least one blade 54 protruding into a void 60 defined between the upper jaw 30 and lower jaw 40, such that when a high voltage cable is secured within the void 60 and squeezed between the upper jaw 30 and lower jaw 40, the outer insulation jacket is cut by the blade 54 when the handles 20 are rotated about the cable axis.

3. An improved lineman type plier of claim 1 or 2, wherein the lower jaw 40 is integrally formed with the cutter 44, the protrusion 42, and the lower jaw tip 43.

4. An improved lineman type plier of claim land 2, wherein the cutter 44 and the protrusion 42 are integrally formed with the lower jaw 40.

5. An improved lineman type plier of claim land 2, wherein the cutter 44 is discretely formed and arranged to removably engage the lower jaw tip 43 thereby allowing for cutter 44 replacement, change, or removal.

6. An improved lineman type plier of claims 1 and 2, wherein the tooth 32 is constructed and arranged to deform the insulation at the cut end of the cable.

7. An improved lineman type plier of claims 1 and 2, wherein the tooth 32 is constructed and arranged to pierce and penetrate the insulation at the cut end of the cable.

8. An improved lineman type plier of claim land 2, wherein at least one tooth 32 is discretely formed and cooperatively constructed to removably engage the upper jaw tip 33, thereby allowing for the replacement, change, or removal of the tooth 32.

9. An improved lineman type plier of claims 1 and 2, wherein the upper transverse gripping edge 34 and the lower transverse gripping edge 46 are cooperatively constructed and arranged to capture, deform, and securely hold a neutral wire.

10. An improved lineman type plier of claim 2, wherein the at least one blade 54 with a guard 55 protrudes into the void 60, the guard 55 being constructed and arranged to cover the blade 54 until a high voltage cable is secured within the void 60 and squeezed between the upper jaw 30 and lower jaw 40, the outer insulation jacket being cut by the blade 54 when the handles 20 are rotated about the cable's axis.

11. An improved lineman type plier of claim 2, wherein the at least one blade 54 and a guard 55 are fixated within a cartridge and removabley installed within the upper jaw tip 33 or lower jaw tip 43, the guard 55 being constructed and arranged to cover the blade 54 until a high voltage cable is secured within the void 60 and the high voltage cable is squeezed between the upper jaw 30 and lower jaw 40 which projects the blade 54 from the guard 55, such that when the handles 20 are rotated about the cable axis the blade 54 cuts the outer insulation jacket.
